(19) United States
(12) Patent Application Publication
(10) Pub. No.: US 2026/0027467 A1
(43) Pub. Date: Jan. 29, 2026

(54) SYSTEMS AND METHODS FOR EMPHASIZING EXTERNAL SOUNDS FOR OUTPUT VIA SPEAKERS DURING GAME PLAY

(71) Applicant: Sony Interactive Entertainment Inc., Tokyo (JP)

(72) Inventors: Victoria Dorn, San Mateo, CA (US); Andres Aceves, Harvey, IL (US); Sankalp Mohanty, San Mateo, CA (US)

(21) Appl. No.: 18/787,924

(22) Filed: Jul. 29, 2024

(51) Int. Cl. A63F 13/54

(52) U.S. Cl. CPC A63F 13/54

(57) ABSTRACT

A method for reproducing external sounds for output during game play is described. The method includes receiving audio data captured from a sound output by a real-world object during a play of a game by a user and determining that the sound is beneficial to the user. The method includes modifying the audio data to output modified audio data in response to determining that the sound is beneficial to the user. The method includes providing the modified audio data to facilitate outputting the modified audio data via a speaker of a client device to emphasize the sound beneficial to the user.

### FIELD

The present disclosure relates to systems and methods for emphasizing external sounds for output via speakers during game play are described.

### BACKGROUND

In recent years, video games have become extremely popular. Video games are used not only for entertainment, but also for instructional purposes. Players typically interact with a gaming application through computer or console peripherals, such as, keyboard, mouse, joysticks, a wide variety of game pads, and controllers. A variety of these video games are played in which users wear headphones.

With the ongoing trends and growth in video gaming, it is beneficial to find better platform architectures for gaming applications that continue to enhance the user experience. It is in this context that embodiments of the invention arise.

### SUMMARY

Embodiments of the present disclosure provide systems and methods for emphasizing external sounds for output via speakers during game play.

In an embodiment, external sounds, such as, dog walking, train passing by, external communication, etc., will leak into audio of a game play output via speakers of a headphone speakers, as a noise canceling feature of the headphone is not foolproof. However, the external sounds may be beneficial to a player experience in that the external sounds provide a more natural experience to the player. As such, the external sounds are emphasized. For example, audio of the external sounds is localized directionally in a three-dimensional (3D) audio space. To illustrate, the audio of the external sounds is captured and reproduced to be played on a sound system, such as the speakers of the headphone or speakers of a television, for better clarity and accurate simulation of distance. Also, as another example, to emphasize the external sounds, the audio data of the external sounds is split into different portions, such as low and high frequency. The different portions are delivered to different parts of a speaker system. For example, sounds of a passing train may split and delivered such that a higher frequency portion (e.g., horn) is sent to the headphone, and the lower frequency portion (mass of air and wheels) is sent to subwoofers.

In one embodiment, a method for reproducing external sounds for output during game play is described. The method includes receiving audio data captured from a sound output by a real-world object during a play of a game by a user and determining that the sound is beneficial to the user. The method includes modifying the audio data to output modified audio data in response to determining that the sound is beneficial to the user. The method includes providing the modified audio data to facilitate outputting the modified audio data via a speaker of a client device to emphasize the sound beneficial to the user.

In an embodiment, a server system reproducing external sounds for output during game play is described. The server system includes a processor and a memory device coupled to the processor. The processor receives audio data captured from a sound output by a real-world object during a play of a game by a user. The processor determines that the sound is beneficial to the user and modifies the audio data to output modified audio data in response to the determination that the sound is beneficial to the user. The processor provides the modified audio data to facilitate outputting the modified audio data via a speaker of a client device to emphasize the sound beneficial to the user.

Some advantages of the herein described systems and methods include providing a gaming system in which a user is engaged with reality, such as sounds output in a real-world environment. In this manner, the user can enjoy a video game, but at the same time, be in touch with the real-world environment. For example, if there is an emergency alarm that is generated while the user is playing the video game and the user is wearing noise cancellation headphones, the gaming system will emphasize sounds of the emergency alarm to alert the user of a real-world emergency.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRA WINGS

Various embodiments of the present disclosure are best understood by reference to the following description taken in conjunction with the accompanying drawings in which:

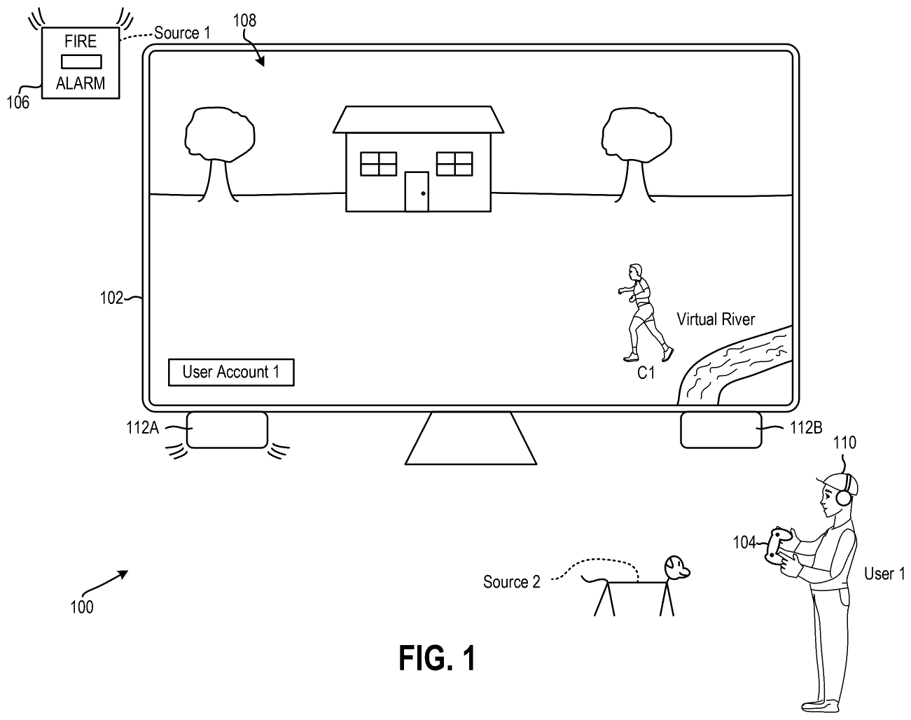

FIG. 1 is a diagram of an embodiment of a system to illustrate modification of sounds that are output within a real-world environment surrounding a user.

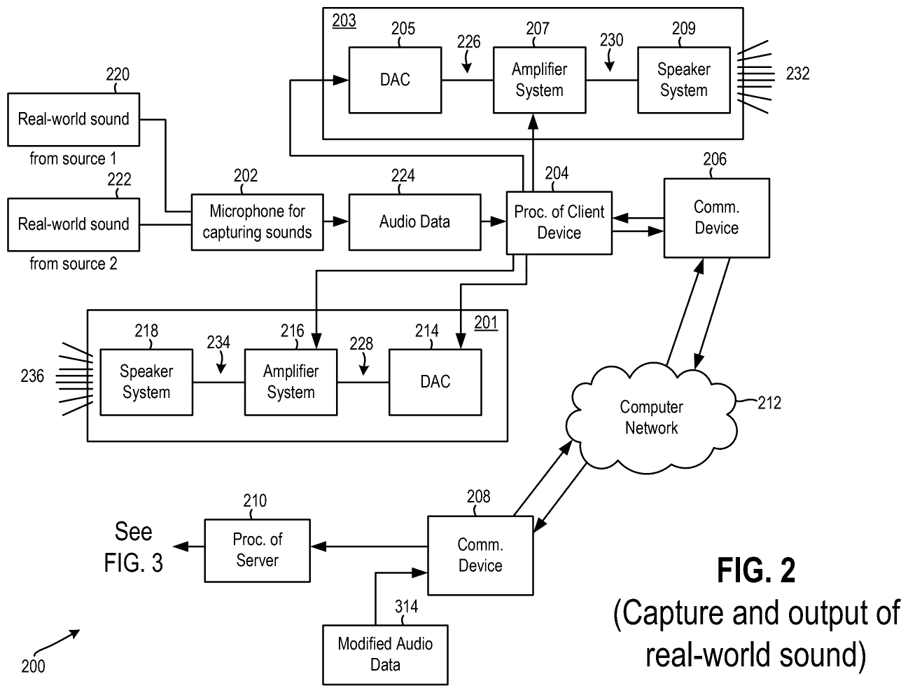

FIG. 2 is a diagram of an embodiment of a system to illustrate a method for modifying sounds that are output from one or more sources, such as real-world objects, in a real-world environment, and/or sounds that are output in a video game.

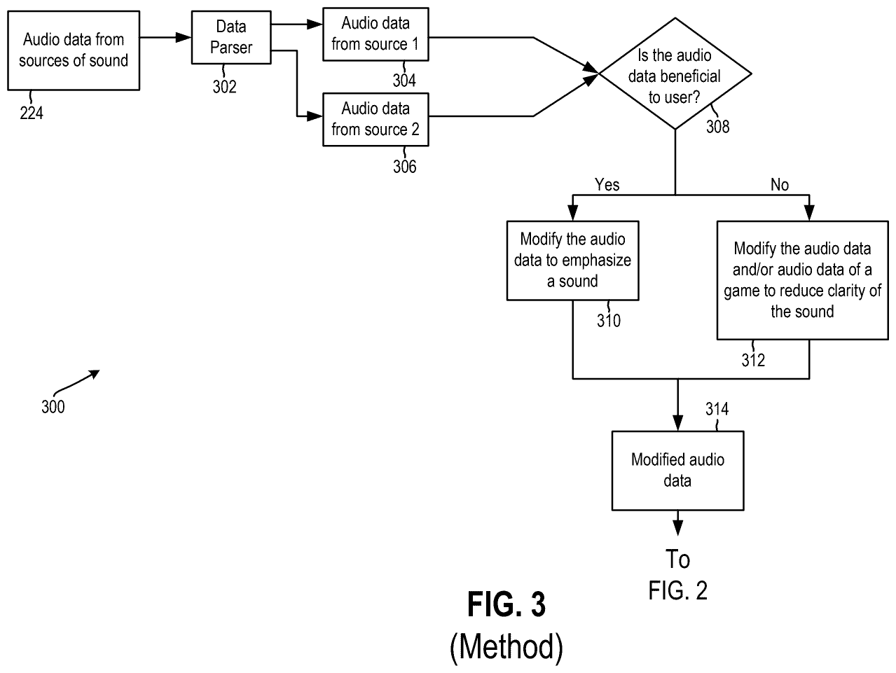

FIG. 3 is a diagram of an embodiment of a system to illustrate the method for modifying sounds that are output from the one or more sources, and/or the sounds that are output in the video game.

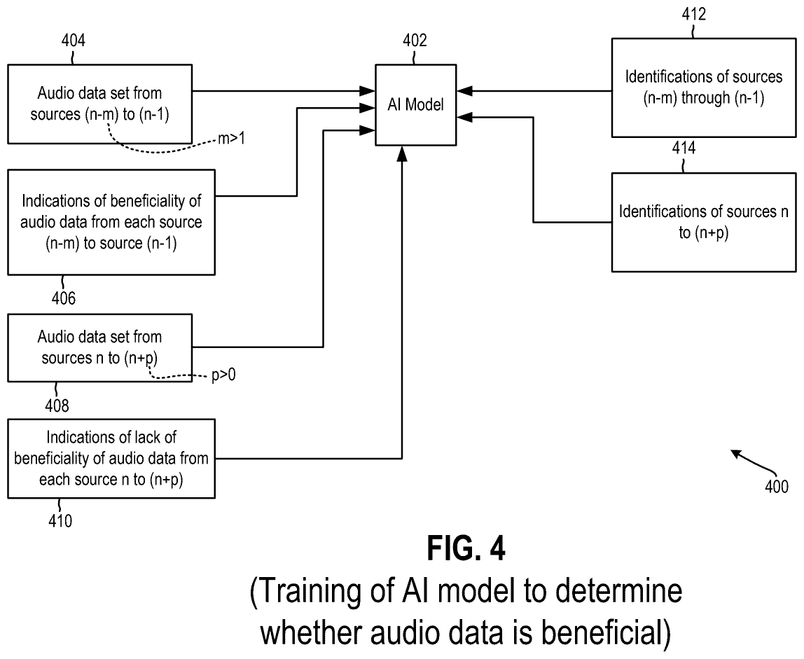

FIG. 4 is a diagram of an embodiment of a system to illustrate training of an artificial intelligence (AI) model to determine whether audio data that is generated based on sound emitted from or uttered by a source is beneficial to a user.

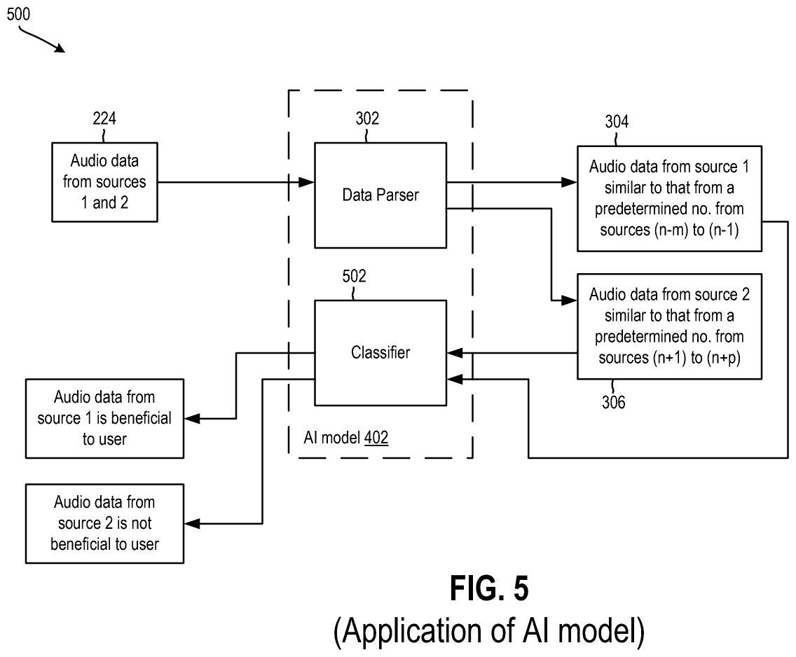

FIG. 5 is a diagram of an embodiment of a system to illustrate a determination of whether audio data from a source is beneficial to a user and a determination of whether audio data from a source lacks beneficiality to a user.

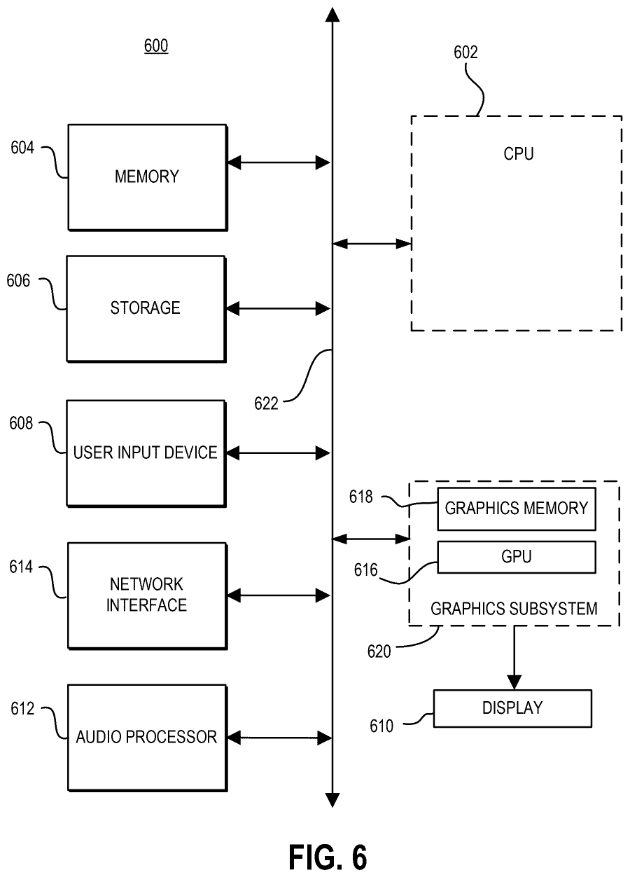

FIG. 6 illustrates components of an example device that can be used to perform aspects of the various embodiments of the present disclosure.

### DETAILED DESCRIPTION

Systems and methods for emphasizing external sounds for output via speakers during game play are described. It should be noted that various embodiments of the present disclosure are practiced without some or all of these specific details. In other instances, well known process operations have not been described in detail in order not to unnecessarily obscure various embodiments of the present disclosure.

FIG. 1 is a diagram of an embodiment of a system 100 to illustrate modification of sounds that are output within a real-world environment surrounding a user 1. The system 100 includes a display device 102 and a hand-held controller 104. Examples of the display device 102 include a desktop computer and a smart television. The display device 102 has a display screen, such as a light emitting diode (LED) screen or a plasma display screen. An example of the hand-held controller 104 include a PlayStation™ 5 (PS5) gaming controller that includes two handle bars extending from body, a touch pad, and one or more buttons, such as multiple directional buttons and multiple action buttons. The system 100 further includes a headphone 110, such as a pair of earphones, which is worn over cars of the user 1. As an example, the headphone 110 has a noise filtering feature, no such as a noise cancellation feature, to filter out sounds emitted from or uttered by one or more sources, such as a source 1 and a source 2, in the real-world environment. The display device 102 includes one or more speakers, such as the speaker 112A and another speaker 112B, to output sounds to the real-world environment. It should be noted that the sounds emitted from or uttered by one or more sources, described herein, are sometimes referred to herein as external sounds. Each source, such as the sources 1 and 2, described herein, is an example of a real-world object in a real-world environment. An example of a source is another user, such as a child or another person.

The real-world environment includes a fire alarm device 106, which is an example of the source 1 of sound. An example of the fire alarm device 106 includes a fire detector. Also, the real-world environment has the source 2, such as a dog. It should be noted that a distance between the user 1 and the source 1 is greater than the distance between the user 1 and the source 2.

The user 1 operates the one or more buttons of the hand-held controller 104 to log into a user account 1, which is assigned to the user 1 by a processor of a server system. An example of the server system is a combination of one or more processors and one or more memory devices. The one or more processors of the server system are coupled to the one or more memory devices of the server system. Examples of a processor, as used herein, include a central processing unit, a graphical processing unit, and a microprocessor. Examples of a memory device include a read-only memory and a random access memory. Upon logging into the user account 1, the processor of the server system allows access to a game program to the display device 102 operated by the user 1. When the game program is accessed, a virtual scene 108 of a video game is displayed on the display screen of the display device 102. In the virtual scene 108, a movement of virtual character C1 is controlled by the user 1 when the user 1 operates the one or more buttons of the hand-held controller 104. The virtual scene 108 further includes other virtual objects, such as a virtual river, a virtual house, and virtual trees.

During a play of the video game, one or more sounds emitted from the virtual scene 108, such as from one or more of the virtual character C1, the virtual river and the virtual trees, are output via the headphone 110 to the user 1. Also, during the play of the video game, there is an alarm sound that is emitted from the source 1 and/or a sound, such as a barking sound or a meow sound or a crying sound, that is emitted from the source 2. For example, during a time period in which the video game is played by the user 1, the sources 1 and 2 emit a variety of sounds.

When the user 1 is wearing the headphone 110, e.g., a headphone with the noise filtering feature, the user 1 hears the one or more sounds emitted from the virtual scene 108, cannot hear the sound output from the source 1 clearly, and hears the sound output from the source 2. For example, when the source 2 is at a location within the real-world environment closer to the user 1 compared to a location of the source 1 within the real-world environment, the user 1 hears the sound emitted from the source 2 more clearly compared to the sound emitted from the source 1. Also, in the example, when the sound is emitted from the virtual scene 108 via the headphone 110, the user 1 cannot hear the sound emitted from the source 1 clearly.

A client device captures, such as records, one or more of the sounds emitted from sources, such as the sources 1 and 2, in the real-world environment to generate audio data from the one or more of the sounds, and sends the audio data to the processor of the server system for modification of the one or more of the sounds. For example, one or more microphones of the client device captures the one or more sounds from the sources in the real-world environment to generate the audio data and sends the audio data via a computer network to the processor of the server system. The processor of the server system modifies the audio data generated based on one or more of the sounds emitted from the sources to output modified audio data and sends the modified audio data via the computer network to the client device.

The client device converts the modified audio data into modified sounds that are output in the real-world environment. For example, the speakers 112A and 112B output the modified sounds in the real-world environment. The modified sounds are output to immerse the user 1 in the real-world environment. For example, the modified sounds are output via the speakers 112A and 112B to alert the user 1 regarding any emergency occurring in the real-world environment. As another example, the modified sounds are output to suppress the sound emitted from the source 2 and to enhance the sound emitted from the source 1 to alert the user regarding the emergency.

An example of a client device includes a combination of a display device, a hand-held controller, and a headphone. Another example of the client device includes a combination of a game console, a display device, a hand-held controller, and a headphone. To illustrate, the game console is coupled to the display device 102 and to the hand-held controller 104. Also, in the illustration, the headphone 110 is coupled to the game console. Yet another example of the client device includes a combination of a computer, one or more input devices, one or more cameras, and a headphone. Examples of an input device, as used herein, include a keyboard, the hand-held controller 104, a keypad, a mouse, a stylus, a microphone, and a touchscreen.

In one embodiment, instead of or in addition to the fire alarm device 106, another source, such as a smoke alarm device, is used. An example of the smoke alarm device includes a smoke detector.

In an embodiment, in addition to or instead of the dog, the real-world environment includes another real-world objects, such as a cat or another pet or a human.

In one embodiment, instead of the source 1, a source of sound is a user (not shown). For example, the user (not shown) utters sounds to indicate something important, such as, “Earthquake!”, or “Run, there is a fire!”, to the user 1 during the play of the video game. The user is an example of a real-world object.

FIG. 2 is a diagram of an embodiment of a system 200 to illustrate a method for modifying sounds that are output from the sources 1 and/or 2, and/or sounds that are output in the video game. FIG. 3 is a diagram of an embodiment of a system 300 to illustrate the method for modifying sounds that are output from the sources 1 and/or 2, and/or sounds that are output in the video game.

With reference to FIG. 2, the system 200 includes a microphone system 202, a processor 204 of the client device, a communication device 206, another communication device 208, a processor system 210 of the server system, and a computer network 212. As an example, the processor system 210 includes the one or more processors of the server system. To illustrate, the processor system 210 includes multiple processors that are coupled to each other. Examples of a computer network, as used herein, include a local area network, a wide area network, and a combination thereof. To illustrate, the local area network is an intranet and the wide area network is the Internet. As an example, the microphone system 202 includes the one or more microphones. To illustrate, the one or more microphones of the microphone system 202 are located within the headphone 110 or within the display device 102 or a combination thereof. As another illustration, the one or more microphones of the microphone system 202 are located within the game console. An example of a microphone includes a transducer that converts sound into an electrical signal, such as audio data. Examples of a communication device, as used herein, include a network interface controller, such as a network interface card (NIC).

The system 200 further includes an audio device 201, which includes a digital to analog converter (DAC) 214, an amplifier system 216, and a speaker system 218. As an example, the audio device 201 is a part of the display device 102 (FIG. 1). To illustrate, the speaker system 218 includes the one or more speakers, such as the speakers 112A and 112B (FIG. 1), of the display device 102. As an example, a speaker, as used herein, includes an electroacoustic transducer that converts an electrical signal, such as audio data, into sound.

The system 200 includes another audio device 203, which includes a DAC 205, an amplifier system 207, and a speaker system 209. As an example, the speaker system 209 includes one or more speakers of the headphone 110 (FIG. 1). As an example, an amplifier system includes an amplitude amplifier and a frequency amplifier. To illustrate, the amplitude amplifier increases or decreases an amplitude, of a modified audio signal and the frequency amplifier increases or decreases a frequency of the modified audio signal.

Each of an amplitude and a frequency is an example of a parameter. It should be noted that a frequency, as used herein, has a value and an amplitude, as used herein, has a value. To illustrate, a value, as used herein, is a real number.

The microphone 202 is coupled to the processor 204, which is coupled to the communication device 206. The processor 204 is coupled to the DAC 214, which is coupled to the amplifier system 216. The amplifier system 216 is coupled to the speaker system 218. Similarly, the processor 204 is coupled to the DAC 205, which is coupled to the amplifier system 207. The processor 204 is also coupled to the amplifier system 207. The amplifier system 207 is coupled to the speaker system 209.

The communication device 206 is coupled to the computer network 212 which is coupled to the communication device 208. The communication device 208 is coupled to the processor system 210.

The one or more microphones of the microphone system 202 capture one or more sounds that are emitted from the sound sources within the real-world environment. For example, the one or more microphones capture a sound 220 that is emitted by the source 1 and capture another sound 222 that is emitted by the source 2 in the real-world environment surrounding the user 1. To illustrate, an example of the sound 220 is the alarm sound or a sound of a distress signal. As another illustration, an example of the sound 222 is the barking sound. The one or more microphones of the microphone system 202 convert the sounds 220 and 222 into audio data 224 and provide the audio data 224 to the processor 204.

The processor 204 provides the audio data 224 to the communication device 204. The communication device 204 applies a network communication protocol, such as a transmission control protocol over Internet protocol (TCP/IP), to generate one or more network packets from the audio data 224. The communication device 204 sends the one or more network packets via the computer network 212 to the communication device 208. The communication device 208 applies the network communication protocol to the one or more network packets to extract the audio data 224, and provides the audio data 224 to the processor system 210 of the server system.

Referring to FIG. 3, the system 300 includes a data parser 302. As an example, the data parser 302 is a portion of an artificial intelligence (AI) model. To illustrate, the data parser is implemented as a combination of software and hardware. An example of the software includes a computer program and an example of the hardware includes the one or more processors of the server system. As an example, an AI model, as used herein, is a combination of the hardware and software of the server system. To illustrate, an AI model is a neural network that applies machine learning to analyze data and determine a pattern from the data to output a result. As another illustration, an AI model is the server system that implements the machine learning.

The data parser 302 parses the audio data 224 to identify audio data 304 that is generated based on the sound 220 (FIG. 2) and audio data 306 that is generated based on the sound 222 (FIG. 2). For example, the data parser 302 determines that the audio data 224 includes audio data 304 generated based on the sounds emitted from the source 1 and includes audio data 306 generated based on sounds emitted from the source 2.

The data parser 302 provides the audio data 304 and the audio data 306 to a classifier of the AI model. In response to providing the audio data 304 and 306 to the AI model, the classifier of the AI model determines, in an operation 308, whether the audio data 304 or 306 or both is beneficial to a user, such as the user 1. For example, the data parser 302 receives a determination from the classifier of the AI model, indicating that the audio data 304 is beneficial to the user 1 and the audio data 306 is not beneficial to the user 2.

Upon receiving the determination made in the operation 308 that the audio 304 is beneficial to the user 1, the one or more processors of the processor system 210 modify, in an operation 310, the audio data 304 to emphasize, such as highlight or provide clarity to, a sound to be output from the audio data 304. For example, the one or more processors of the processor system 210 control the audio device 201 (FIG. 2) or the audio device 203 (FIG. 2) or a combination thereof to increase an amplitude of the sound to be generated based on the audio data 304 to be greater than a predetermined amplitude threshold and/or increase a frequency of the sound to be generated based on the audio data 304 to be greater than a predetermined frequency threshold to localize the sound in a three-dimensional (3D) audio space of the real-world environment in which the user 1 is located. To illustrate, the one or more processors of the processor system 210 generate an increase amplitude instruction indicating that the amplitude of the sound to be generated based on the audio data 304 to be greater than the predetermined amplitude threshold. Also, the increase amplitude instruction includes an identifier of the audio device 201 or an identifier of the audio device 203 or both the identifiers of the audio devices 201 and 203 for outputting the sound to be generated based on the audio data 304. As another illustration, the one or more processors of the processor system 210 generate an increase frequency instruction indicating that the frequency of the sound to be generated based on the audio data 304 to be greater than the predetermined frequency threshold. Also, the increase frequency instruction includes an identifier of the audio device 201 or an identifier of the audio device 203 or both the identifiers of the audio devices 201 and 203 for outputting the sound to be generated based on the audio data 304. By increasing the amplitude of the sound to be generated based on the audio data 304 to be greater than the predetermined amplitude threshold and/or increasing a frequency of the sound to be generated based on the audio data 304 to be greater than the predetermined frequency threshold, an accurate simulation of distance, in the real-world environment, between the user 1 and the source 1 of the sound is achieved.

As another example, the one or more processors of the processor system 210 control the audio devices 201 and 203 to redirect the audio data 304 from the audio device 201 (FIG. 2) of the display device 102 to the audio device 203 of the headphone 110 to localize a sound to be output, based on the audio data 304, in the 3D audio space. It should be noted that the audio devices 201 and 203 are controlled to modify a location of output of the audio data 304. To illustrate, the one or more processors of the processor system 210 generate a change audio device instruction, which indicates that the audio data 304 be redirected from the audio device 201 to the audio device 203. Also, the change location instruction includes identifiers of the audio devices 201 and 203.

As yet another example, the one or more processors of the processor system 210 control the audio device 201 to output the sound to be generated based on the audio data 304. As still another example, the one or more processors of the processor system 210 control the audio device 203 to output the sound to be generated based on the audio data 304.

As still another example, the one or more processors of the processor system 210 control the audio device 201 to output a sound to be generated based on a first predetermined range of frequencies, such as low frequencies, of the audio data 304. In the example, the one or more processors of the processor system 210 control the audio device 203 to output a sound to be generated based on a second predetermined range of frequencies, such as high frequencies, of the audio data 304. To illustrate, the one or more processors of the processor system 210 distinguish, from the audio data 304, the first predetermined range of frequencies and the second predetermined range of frequencies to identify the first predetermined range of frequencies and the second predetermined range of frequencies. The second predetermined range of frequencies is greater than and exclusive of the first predetermined range of frequencies and is segregated from the first predetermined range of frequencies to modify the audio data 304. The one or more processors of the processor system 210 generate a first primary instruction to the audio device 203 to output the sound based on the second predetermined range of frequencies and generate a second primary instruction to the audio device 201 to output the sound based on the first predetermined range of frequencies. The first primary instruction includes an identifier of the audio device 203 and the second primary instruction includes an identifier of the audio device 201.

As still another example, the one or more processors of the processor system 210 control the audio device 201 to output a sound to be generated based on a first predetermined range of amplitudes, such as low amplitudes, of the audio data 304. In the example, the one or more processors of the processor system 210 control the audio device 203 to output a sound to be generated based on a second predetermined range of amplitudes, such as high amplitudes, of the audio data 304. To illustrate, the one or more processors of the processor system 210 distinguish, from the audio data 304, the first predetermined range of amplitudes and the second predetermined range of amplitudes to identify the first predetermined range of amplitudes and the second predetermined range of amplitudes. The second predetermined range of amplitudes is greater than and exclusive of the first predetermined range of amplitudes and is segregated from the first predetermined range of amplitudes to modify the audio data 304. The one or more processors of the processor system 210 generate a first secondary instruction to the audio device 203 to output the sound based on the second predetermined range of amplitudes and generate a second secondary instruction to the audio device 201 to output the sound based on the first predetermined range of amplitudes. The first secondary instruction includes an identifier of the audio device 203 and the second secondary instruction includes an identifier of the audio device 201.

On the other hand, upon receiving the determination, made in the operation 308, that the audio data 306 is not beneficial to the user 1, the one or more processors of the processor system 210 modify, in an operation 312, the audio data 306 to deemphasize a sound to be output from the audio data 306 to deemphasize a sound to be output from the audio data 306 and/or audio data of the video game to deemphasize a sound to be output from the audio data of the video game. For example, the one or more processors of the processor system 210 control the audio device 201 or the audio device 203 or a combination thereof to decrease an amplitude of the sound to be generated based on the audio data 306 and/or based on the audio data of the video game to be lower than the predetermined amplitude threshold and/or decrease a frequency of the sound to be generated to be less than the predetermined frequency threshold. To illustrate, the one or more processors of the processor system 210 generate a decrease amplitude instruction indicating that the amplitude of the sound to be generated based on the audio data 306 and/or the amplitude of the sound output from the audio data of the video game to be less than the predetermined amplitude threshold. Also, the decrease amplitude instruction includes an identifier of the audio device 201 or an identifier of the audio device 203 or both the identifiers of the audio devices 201 and 203 for outputting the sound to be generated based on the audio data 306 and/or the sound output from the audio data of the video game. As another illustration, the one or more processors of the processor system 210 generate a decrease frequency instruction indicating that the frequency of the sound to be generated based on the audio data 306 and/or the frequency of the sound output from the audio data of the video game to be lower than the predetermined frequency threshold. Also, the decrease frequency instruction includes an identifier of the audio device 201 or an identifier of the audio device 203 or both the identifiers of the audio devices 201 and 203 for outputting the sound to be generated based on the audio data 306 and/or the sound output from the audio data of the video game. When the sound to be output from the audio data 306 and/or audio data of the video game is deemphasized, the sound to be output based on the audio data 304 is emphasized. Also, when the amplitude of the sound to be generated based on the audio data 306 and/or based on the audio data of the video game is controlled to be lower than the predetermined amplitude threshold and/or the frequency of the sound is decreased to be less than the predetermined frequency threshold, a location of the sound is changed in the 3D audio space.

An example of the audio data of the video game includes audio data that is to be output as sounds from a virtual object, such as a virtual character or a virtual background, in the video game. To illustrate, examples of the virtual background include the virtual river, the virtual house, the virtual trees, a virtual mountain, and a virtual vehicle. Also, examples of the virtual character include a virtual vehicle and a virtual monster. Another example of the audio data of the video game includes audio data that is to be output as background music in the video game.

As another example, the one or more processors of the processor system 210 control the audio devices 201 and 203 to redirect the audio data 306 and/or the audio data of the video game from the audio device 203 of the headphone 110 to the audio device 201 of the display device 102. It should be noted that the audio devices 201 and 203 are controlled to modify a location of output of the audio data 306 and/or the audio data of the video game. To illustrate, the one or more processors of the processor system 210 generate a change audio device instruction, which indicates that the audio data 306 and/or the audio data of the video game redirected from the audio device 203 to the audio device 201. Also, in the illustration, the change audio device instruction includes identifiers of the audio devices 201 and 203. The sound to be output from the audio data 306 and/or the sound to be output from the audio data of the video game are deemphasized to emphasize the sound to be output from the audio data 304. Also, when the audio data 306 and/or the audio data of the video game is redirected from the audio device 203 of the headphone 110 to the audio device 201 of the display device 102, a location of the sound to be output based on the audio data 306 and/or the audio data of the video game is changed in the 3D audio space.

As another example, one or more processors of the processor system 210 modify a three-dimensional (3D) location, in the 3D audio space, of the sound to be generated based on the audio data of the video game. To illustrate, the one or processors of the processor system 210 control the audio system 203 to redirect the sound to be generated based on the audio data of the video game, such as the sound of the virtual river, from a right speaker of the speaker system 209 (FIG. 2) to a left speaker of the speaker system 209. The sound is redirected, in the illustration, to deemphasize, such as suppress or reduce, the sound 222 from the source 2, such as the dog. To further illustrate, the one or more processors of the processor system 210 generate a change speaker instruction, which indicates that the sound to be generated based on the audio data of the video game be redirected from the right speaker of the speaker system 209 to the left speaker of the speaker system 209. Also, in the illustration, the change speaker instruction includes identifiers of the left speaker and the right speaker of the speaker system 209. In the further illustration, the one or more processors of the processor system 210 determine that an amplitude of the audio data 306 is large, such as greater than a preset amplitude limit, and/or a frequency of the audio data 306 is greater than a preset frequency limit, to determine that the sound 222 be deemphasized.

As another illustration, the one or processors of the processor system 210 control the audio device 201 to redirect the sound to be generated based on the audio data of the video game, such as the sound of the virtual river, from a right speaker of the speaker system 218 (FIG. 2) to a left speaker of the speaker system 218. The sound is redirected, in the illustration, to deemphasize, such as suppress or reduce, the sound 222 from the source 2, such as the dog. To further illustrate, the one or more processors of the processor system 210 generate a change speaker instruction, which indicates that the sound to be generated based on the audio data of the video game be redirected from the right speaker of the speaker system 218 to the left speaker of the speaker system 218. In the further illustration, the one or more processors of the processor system 210 determine that an amplitude of the audio data 306 is large, such as greater than a preset amplitude limit, and/or a frequency of the audio data 306 is greater than a preset frequency limit, to determine that the sound 222 be deemphasized. Also, in the illustration, the change speaker instruction includes identifiers of the left speaker and the right speaker of the speaker system 218.

The one or more processors of the processor system 210 modify the audio data 304, or the audio data 306, or the audio data of the video game, or the first predetermined range of frequencies, or the second predetermined range of frequencies, or the first predetermined range of amplitudes, or the second predetermined range of amplitudes, or a combination of two or more thereof to output modified audio data 314. To illustrate, the modified audio data 314 includes substantive content, such as words or alphabets or meaning or a combination thereof, of the audio data 304 with the increase amplitude instruction or the increase frequency instruction. In the illustration, the modified audio data 314 includes the audio data 304 by including the substantive content of the audio data 304. As another illustration, the modified audio data 314 includes substantive content, such as words or alphabets or meaning or a combination thereof, of the audio data 306 with the decrease amplitude instruction or the decrease frequency instruction. In the illustration, the modified audio data 314 includes the audio data 306 by including the substantive content of the audio data 304. As another illustration, the modified audio data 314 includes substantive content, such as words or alphabets or meaning or a combination thereof, of the audio data of the video game with the decrease amplitude instruction or the decrease frequency instruction. In the illustration, the modified audio data 314 includes the audio data of the video game by including the substantive content of the audio data of the video game.

An example of an identifier of a device that is coupled to the computer network 212 is a media access control (MAC) address. To illustrate, the audio device 201 is identified using a first MAC address of the display device 102 and the audio device 203 is identified using a second MAC address of the headphone 110.

Referring back to FIG. 2, the one or more processors of the processor system 210 provide the modified audio data 314 and one or more instructions generated by the processor system 210 to the communication device 208. Examples of the one or more instructions generated by the processor system 210 include the increase amplitude instruction, the increase frequency instruction, the decrease amplitude instruction, the decrease frequency instruction, the change audio device instructions, the change speaker instruction, the first primary instruction, the second primary instruction, the first secondary instruction, and the second secondary instruction.

The communication device 208 applies the network communication protocol to the modified audio data 314 and the one or more instructions to generate one or more network packets including the modified audio data 314, and sends the one or more network packets via the computer network 212 to the communication device 206. The communication device 206 applies the network communication protocol to extract the modified audio data 314 and the one or more instructions from the one or more network packets received from the communication device 208, and provides the modified audio data 314 and the one or more instructions to the processor 204.

The processor 204 sends the modified audio data 314 to the DAC 205 of the audio device 203 and/or to the DAC 214 in accordance with the one or more instructions. For example, in response to receiving the increase amplitude instruction having the identifier of the audio device 203, the processor 204 sends the audio data 304 to the DAC 205 with an instruction to the amplitude amplifier of the amplifier system 207 to increase an amplitude of a modified audio signal 226 to be output from the DAC 205. As another example, in response to receiving the decrease amplitude instruction having the identifier of the audio device 203, the processor 204 sends the audio data 304 to the DAC 205 with an instruction to the amplitude amplifier of the amplifier system 207 to decrease an amplitude of the modified audio signal 226 to be output from the DAC 205.

As yet example, in response to receiving the increase frequency instruction having the identifier of the audio device 203, the processor 204 sends the audio data 304 to the DAC 205 with an instruction to the frequency amplifier of the amplifier system 207 to increase a frequency of the modified audio signal 226 to be output from the DAC 205. As another example, in response to receiving the decrease frequency instruction having the identifier of the audio device 203, the processor 204 sends the audio data 304 to the DAC 205 with an instruction to the frequency amplifier of the amplifier system 207 to decrease a frequency of the modified audio signal 226 to be output from the DAC 205.

As another example, in response to receiving the increase amplitude instruction having the identifier of the audio device 201, the processor 204 sends the audio data 306 and/or the audio data of the video game to the DAC 214 with an instruction to the amplitude amplifier of the amplifier system 216 to increase an amplitude of a modified audio signal 228 to be output from the DAC 214. As yet another example, in response to receiving the decrease amplitude instruction having the identifier of the audio device 201, the processor 204 sends the audio data 306 and/or the audio data of the video game to the DAC 214 with an instruction to the amplitude amplifier of the amplifier system 216 to decrease an amplitude of the modified audio signal 228 to be output from the DAC 214.

As still another example, in response to receiving the increase frequency instruction having the identifier of the audio device 201, the processor 204 sends the audio data 306 and/or the audio data of the video game to the DAC 214 with an instruction to the frequency amplifier of the amplifier system 216 to increase a frequency of the modified audio signal 228 to be output from the DAC 214. As yet another example, in response to receiving the decrease frequency instruction having the identifier of the audio device 201, the processor 204 sends the audio data 306 and/or the audio data of the video game to the DAC 214 with an instruction to the frequency amplifier of the amplifier system 216 to decrease a frequency of the modified audio signal 228 to be output from the DAC 214.

As another example, in response to receiving the audio data 304, and the change audio device instruction having the identifier of the audio device 203 without having the identifier of the audio device 201, the processor 204 sends the audio data 304 to the DAC 205 of the audio device 203. In the example, the audio data 304 is not sent to the audio device 201.

As yet another example, in response to receiving the audio data 306, and/or the audio data of the video game, and the change audio device instruction having the identifier of the audio device 201 without having the identifier of the audio device 203, the processor 204 sends the audio data 306 and/or the audio data of the video game to the DAC 214 of the audio device 201. In the example, the audio data 306 and/or the audio data of the video game is not sent to the audio device 203.

As another example, in response to receiving the audio data 304, the change speaker instruction having the identifier of the audio device 203, and an identifier of the left or right speaker of the speaker system 209, the processor 204 sends the audio data 304 to the audio device 203. In the example, the processor 204 generates an instruction for the amplifier system 207 that indicates to the amplifier system 207 to output an amplified audio signal 230 to the left or right speaker identified within the change speaker instruction. To illustrate, the instruction for the amplifier system 207 includes the identifier of the left or right speaker of the speaker system 209. Further, in the example, the processor 204 sends the instruction for the amplifier system 207 to the amplifier system 207.

As yet another example, in response to receiving the second predetermined range of frequencies, and the first primary instruction having the identifier of the audio device 203 without having the identifier of the audio device 201, the processor 204 sends the second predetermined range of frequencies to the DAC 205 of the audio device 203. In the example, the second predetermined range of frequencies is not sent to the audio device 201. Further, in the example, in response to receiving the first predetermined range of frequencies, and second primary instruction having the identifier of the audio device 201 without having the identifier of the audio device 203, the processor 204 sends the first predetermined range of frequencies to the DAC 214 of the audio device 201. In the example, the first predetermined range of frequencies is not sent to the audio device 203.

As still another example, in response to receiving the second predetermined range of amplitudes, and the first secondary instruction having the identifier of the audio device 203 without having the identifier of the audio device 201, the processor 204 sends the second predetermined range of amplitudes to the DAC 205 of the audio device 203. In the example, the second predetermined range of amplitudes is not sent to the audio device 201. Further, in the example, in response to receiving the first predetermined range of amplitudes, and the second secondary instruction having the identifier of the audio device 201 without having the identifier of the audio device 203, the processor 204 sends the first predetermined range of amplitudes to the DAC 214 of the audio device 201. In the example, the first predetermined range of amplitudes is not sent to the audio device 203.

The DAC 205 converts the modified audio data 314, such as the audio data 304, or the second predetermined range of frequencies, or the second predetermined range of amplitudes, or the audio data 306, or the audio data of the video game, from a digital format to an analog format to output the modified audio signal 226, and provides the modified audio signal 226 to the amplifier system 207. The amplifier system 207 amplifies, such as increases or decreases, an amplitude and/or frequency of the modified audio signal 226 to output the amplified audio signal 230. For example, when the one or more instructions received from the processor system 210 include the increase amplitude instruction, the processor 204 generates and sends an instruction to the amplitude amplifier of the amplifier system 207. In response to receiving the instruction, in the example, the amplitude amplifier of the amplifier system 207 increases an amplitude of the modified audio signal 226. In the example, when the one or more instructions received from the processor system 210 include the decrease amplitude instruction, the processor 204 generates and sends another instruction to the amplitude amplifier of the amplifier system 207. In response to receiving the other instruction, in the example, the amplitude amplifier of the amplifier system 207 decreases an amplitude of the modified audio signal 226.

Continuing with the example, when the one or more instructions received from the processor system 210 include the increase frequency instruction, the processor 204 generates and sends yet another instruction to the frequency amplifier of the amplifier system 207. In response to receiving the yet another instruction, in the example, the frequency amplifier of the amplifier system 207 increases a frequency of the modified audio signal 226. In the example, when the one or more instructions received from the processor system 210 include the decrease frequency instruction, the processor 204 generates and sends still another instruction to the frequency amplifier of the amplifier system 207. In response to receiving the still another instruction, in the example, the frequency amplifier of the amplifier system 207 decreases a frequency of the modified audio signal 226.

The amplifier system 207 determines whether the instruction for the amplifier system 207 indicating the left or right speaker of the speaker system 209 is received from the processor 204. Upon determining that the instruction indicating the left or right speaker of the speaker system 209 is received, the amplifier system 207 provides the amplified audio signal 230 to the left or right speaker of the speaker system 209 as identified within the instruction for the amplifier system 207. On the other hand, upon determining that the instruction is not received, the amplifier system 207 provides the amplified audio signal 230 to both the left and right speakers of the speaker system 209. The left speaker or the right speaker or both the speakers of the speaker system 209 convert the amplified audio signal 230 into sound 232. In this manner, the sound 220 that is emitted by the source 1 is reproduced as the sound 232 after being modified.

As another example, in response to receiving the change speaker instruction having the identifier of the audio device 201 and an identifier of the left or right speaker of the speaker system 218, the processor 204 sends the audio data 306 and/or the audio data of the video game to the audio device 201. In the example, the processor 204 generates an instruction for the amplifier system 216 that indicates to the amplifier system 216 to output an amplified audio signal 234 to the left or right speaker identified within the change speaker instruction. To illustrate, the instruction for the amplifier system 216 includes the identifier of the left or right speaker of the speaker system 218. Further, in the example, the processor 204 sends the instruction for the amplifier system 216 to the amplifier system 216.

The DAC 214 converts the modified audio data 314, such as the audio data 306, or the audio data of the video game, or the first predetermined range of frequencies, or the first predetermined range of amplitudes, or the audio data 304, from a digital format to an analog format to output the modified audio signal 228, and provides the modified audio signal 228 to the amplifier system 216. The amplifier system 216 amplifies, such as increases or decreases, an amplitude and/or frequency of the modified audio signal 228 to output the amplified audio signal 234. For example, when the one or more instructions received from the processor system 210 include the increase amplitude instruction, the processor 204 generates and sends an instruction to the amplitude amplifier of the amplifier system 216. In response to receiving the instruction, in the example, the amplitude amplifier of the amplifier system 216 increases an amplitude of the modified audio signal 228. In the example, when the one or more instructions received from the processor system 210 include the decrease amplitude instruction, the processor 204 generates and sends another instruction to the amplitude amplifier of the amplifier system 216. In response to receiving the other instruction, in the example, the amplitude amplifier of the amplifier system 216 decreases an amplitude of the modified audio signal 228. Continuing with the example, when the one or more instructions received from the processor system 210 include the increase frequency instruction, the processor 204 generates and sends yet another instruction to the frequency amplifier of the amplifier system 216. In response to receiving the yet another instruction, in the example, the frequency amplifier of the amplifier system 216 increases a frequency of the modified audio signal 228. In the example, when the one or more instructions received from the processor system 210 include the decrease frequency instruction, the processor 204 generates and sends still another instruction to the frequency amplifier of the amplifier system 216. In response to receiving the still another instruction, in the example, the frequency amplifier of the amplifier system 216 decreases a frequency of the modified audio signal 228.

The amplifier system 216 determines whether the instruction for the amplifier system 216 indicating the left or right speaker of the speaker system 218 is received from the processor 204. Upon determining that the instruction is received, the amplifier system 216 provides the amplified audio signal 234 to the left or right speaker of the speaker system 218 as identified within the instruction for the amplifier system 216. On the other hand, upon determining that the instruction is not received, the amplifier system 216 provides the amplified audio signal 234 to both the left and right speakers of the speaker system 218. The left speaker or the right speaker or both the speakers of the speaker system 218 convert the amplified audio signal 234 into sound 236. In this manner, the sound 222 that is emitted by the source 2 is reproduced as the sound 236 after being modified.

In an embodiment, instead of the processor 204, multiple processors, including a first processor and a second processor, are used and perform functions described herein as being performed by the processor 204. For example, a first processor is implemented within the display device 102 (FIG. 1), a second processor is implemented within the headphone 101 (FIG. 1), and a third processor is of the client device. In the example, the client device includes the display device 102 and the headphone 101. Also, the third processor controls the first and second processor to execute the functions, described herein, as being performed by the processor 204.

In an embodiment, one or more of the operations 308, 310, and 312 are performed at a client device.

FIG. 4 is a diagram of an embodiment of a system 400 to illustrate training of an artificial intelligence (AI) model 402 to determine whether audio data that is generated based on sound emitted by or uttered from a source is beneficial to a user. The AI model 402 is an example of the AI model described above. The system 400 includes the AI model 402. An example of an AI model includes a computer program that is trained based on a set of data to recognize patterns and make decisions. To illustrate, the AI model is executed by the processor system 210 (FIG. 2) of the server system to receive the set of data and make conclusions based on the set of data.

The system 400 further includes an audio data set 404 that is generated based on sounds emitted or uttered by multiple sources (n−m) through (n−1), where n is an integer greater than m, and m is an integer greater than one, in one or more real-world environments. For example, one or more microphones of one or more client devices capture one or more sounds emitted from the one or more of the sources (n−m) through (n−1) to generate the audio data set 404. To illustrate, a first microphone of a first client device captures sound emitted from the source (n−m) in a first real-world environment in which the first client device is located and a second microphone of a second client device captures sound emitted from the source (n−m+1) in a second real-world environment in which the second client device is located. In the illustration, the first real-world environment is exclusive of the second real-world environment. Examples of a real-world environment include a city, a building, a state, a country, a geographic location, a region, an area, a block, a house, and a room.

As an example, audio data of the audio data set 404 is sometimes referred to herein as audio information. To illustrate, each audio data of the audio data set 404 is a block of data generated based on sounds emitted by or uttered from a source. To further illustrate, a predetermined number of audio data, such as a predetermined number of blocks of data, of the audio data set 404 is generated based on sounds emitted by or uttered from the predetermined number of sources from the sources (n−m) through (n−1).

Examples of the sources (n−m) through (n−1), as described herein, include the source 1 and other sources in one or more real-world environments. To illustrate, the other sources include sources of sound, such as a train, an airplane, a vehicle, a car, a smoke alarm, a fire truck, and a garbage truck.

The system 400 further includes indications 406, such as classifications, of beneficiality of the audio data set 404. For example, a first one of the indications 406 includes that first audio data of the audio data set 404 from the source (n−m) is beneficial to a user and a second one of the indications 406 includes that second audio data of the audio data set 404 from the source (n−m+1) is beneficial to a user.

The system 400 also includes an audio data set 408 that is generated based on sounds emitted or uttered by multiple sources n through (n+p) in one or more real-world environments, where p is an integer greater than zero. For example, one or more microphones of one or more client devices capture one or more sounds emitted from the one or more of the sources n through (n+p) to generate the audio data set 408. To illustrate, a first microphone of a first client device captures sound emitted from the source n in a first real-world environment in which the first client device is located and a second microphone of a second client device captures sound emitted from the source (n+1) in a second real-world environment in which the second client device is located. In the illustration, the first real-world environment is exclusive of the second real-world environment.

As an example, audio data of the audio data set 408 is sometimes referred to herein as audio information. To illustrate, each audio data of the audio data set 408 is a block of data generated based on sounds emitted by or uttered from a source. To further illustrate, the predetermined number of audio data, such as the predetermined number of blocks of data, of the audio data set 408 is generated based from sounds emitted by or uttered from the predetermined number of sources from the sources n through (n+p).

Examples of the sources n through (n+p), as described herein, include the source 2, and additional sources in one or more real-world environments. To illustrate, the additional sources include sources of sounds, such as an animal and a human.

The system 400 further includes indications 410, such as classifications, of lack of beneficiality of the audio data set 408. For example, a first one of the indications 410 includes that first audio data of the audio data set 408 from the source n is not beneficial to a user and a second one of the indications 410 includes that second audio data of the audio data set 408 from the source (n+1) is not beneficial to a user. One or more client devices having one or more microphones that capture sounds emitted from or uttered by the sources (n−m) through (n+p) are coupled to the AI model 402 via the computer network 212 (FIG. 2).

The system 400 also includes identifications 412 of the sources (n−m) through (n−1) and identifications 414 of the sources n through (n+p). For example, one of the sources (n−m) through (n−1) is identified as the source 1 and one of the sources n through (n+p) is identified as the source 2. To illustrate, the AI model 404 receives from a first client device, a first identifier that indicates that audio data of the audio data set 404 is generated based on sounds emitted by or uttered from one of the sources (n−m) through (n−1). In the illustration, the first identifier identifies the one of the sources (n−m) through (n−1). Also, the first identifier indicates an association with, such as a link to or a one-to-one relationship with or a unique relationship with, a first combination of one or more amplitudes and one or more frequencies of the audio data of the audio data set 404. Continuing with the illustration, the AI model 404 receives from the first client device or a second client device, a second identifier that indicates that audio data of the audio data set 408 is generated based on sounds emitted by or uttered from one of the sources n through (n+p). In the illustration, the second identifier identifies the one of the sources n through (n+p). Also, the second identifier indicates an association with, such as a link to or a one-to-one relationship with or a unique relationship with, a second combination of one or more amplitudes and one or more frequencies of the audio data of the audio data set 408. In the illustration, one or more users use one or more input devices of the first client device or the second client device or a combination thereof to provide one or more selections indicating the first and second combinations, the association between the first combination and the one of the sources (n−m) through (n−1), and the association between the second combination and the one of the sources n through (n+p). Upon receiving the one or more selections, the first client device generates the first identifier and the second client device generates the second identifier.

The AI model 402 is trained based on the audio data set 404, the indications 406, the audio data set 408, the indications 410, the identifications 412, and the identifications 414. For example, the AI model 402 receives a first one of the indications 406 within a predetermined time period from receipt of a first audio data of the audio data set 404 and a first one of the identifications 412 from a first client device that captures sounds uttered by or emitted from a first one of the sources (n−m) through (n−1). The first one of the sources (n−m) through (n−1) is identified by the first one of the identifications 412. The AI model 402 receives a second one of the indications 406 within the predetermined time period from receipt of a second audio data of the audio data set 404 and a second one of the identifications 412 from a second client device that captures sounds uttered by or emitted from a second one of the sources (n−m) through (n−1). The second one of the sources (n−m) through (n−1) is identified by the second one of the identifications 412. In response to receiving the first one of the indications 406 within the predetermined time period, the AI model 402 classifies the first audio data of the audio data set 404 as being beneficial to a user. Similarly, in response to receiving the second one of the indications 406 within the predetermined time period, the AI model 402 classifies the second audio data of the audio data set 404 as being beneficial to a user. In the example, the first audio data of the audio data set 404 is generated by the first client device based on sounds uttered by or emitted from the first one of the sources (n−m) through (n−1), and the sounds are beneficial to a user. Also, in the example, the second audio data of the audio data set 404 is generated by the second client device based on sounds uttered by or emitted from the second one of the sources (n−m) through (n−1), and the sounds are beneficial to a user.

In the example, the first one of the indications 406 is generated by the first client device and the second one of the indications 406 is generated by the second client device. To illustrate, a selection identifying the first one of the indications 406 is received from a first user via an input device of the first client device and a selection identifying the second one of the indications 406 is received from a second user via an input device of the second client device. As another example, a selection identifying the first one of the indications 406 in the preceding example is received from a user via an input device of a client device and a selection identifying the second one of the indications 406 in the preceding example is received from the same user via the input device of the client device.

As another example, the AI model 402 receives a first one of the indications 410 within the predetermined time period from receipt of a first audio data of the audio data set 408 and a first one of the identifications 414 from a first client device that captures sounds uttered by or emitted from a first one of the sources n through (n+p). The first one of the sources n through (n+p) is identified by the first one of the identifications 414. The AI model 402 receives a second one of the indications 410 within the predetermined time period from receipt of a second audio data of the audio data set 408 a second one of the identifications 414 from a second client device that captures sounds uttered by or emitted from a second one of the sources n through (n+p). The second one of the sources n through (n+p) is identified by the second one of the identifications 414. In response to receiving the first one of the indications 410 within the predetermined time period, the AI model 402 classifies the first audio data of the audio data set 408 as not being beneficial, such as lacking beneficiality, to a user. Similarly, in response to receiving the second one of the indications 410 within the predetermined time period, the AI model 402 classifies the second audio data of the audio data set 408 as lacking beneficiality to a user. In the example, the first audio data of the audio data set 408 is generated by the first client device based on sounds uttered by or emitted from the first one of the sources n through (n+p), and the sounds are not beneficial to a user. Also, in the example, the second audio data of the audio data set 408 is generated by the second client device based on sounds uttered by or emitted from the second one of the sources n through (n+p), and the sounds are not beneficial to a user.

In the example, the first one of the indications 410 is generated by the first client device and the second one of the indications 410 is generated by the second client device. To illustrate, a selection identifying the first one of the indications 410 is received from a first user via an input device of the first client device and a selection identifying the second one of the indications 410 is received from a second user via an input device of the second client device. As another example, a selection identifying the first one of the indications 410 in the preceding example is received from a user via an input device of a client device and a selection identifying the second one of the indications 410 in the preceding example is received from the same user via the input device of the client device.

FIG. 5 is a diagram of an embodiment of a system 500 to illustrate a determination of whether the audio data 304 (FIG. 3) generated based on sounds, such as the sound 220 (FIG. 2), from the source 1 is beneficial to a user and a determination of whether the audio data 306 (FIG. 3) generated based on sounds, such as the sound 222 (FIG. 2), from the source 2 lacks beneficiality to a user. The system 500 includes the AI model 402, which includes the data parser 302 and a classifier 502. The data parser 302 is sometimes referred to herein as an audio data identifier. The data parser 302 is coupled to the classifier 502.

The data parser 302 receives the audio data 224 and determines that the audio data 224 includes the audio data 304 and the audio data 306. For example, the data parser 302 determines a first frequency and a first amplitude of a first portion of the audio data 224 and a second frequency and a second amplitude of a second portion of the audio data 224. To illustrate, the data parser 302 identifies that a first set of amplitudes of the first portion of the audio data 224 repeat at the first frequency and determine the first amplitude as a statistical amplitude, such as a mean or median amplitude, from a first plurality of amplitudes of the first portion of the audio data 224. In the illustration, the first set of amplitudes lie within a first predetermined range. Further in the illustration, the data parser 302 identifies that a second set of amplitudes of the second portion of the audio data 224 repeat at the second frequency and determine the second amplitude as a statistical amplitude, such as a mean or median amplitude, from a second plurality of amplitudes of the second portion of the audio data 304. In the illustration, the second set of amplitudes lie within a second predetermined range.

Continuing with the example, the data parser 302 compares the first amplitude of the first portion of the audio data 224 with the one or more amplitudes of the predetermined number and compares the first frequency with the one or more frequencies of the predetermined number. The one or more amplitudes are from a first set of combinations, including the first combination, of the audio data set 404 (FIG. 4) and the one or more frequencies are from the first set of combinations of the audio data set 404. In response to determining that the first amplitude is within a preset amplitude range from a statistical value of the one or more amplitudes of the predetermined number from the first set of combinations of the audio data set 404 and the first frequency is within a preset frequency range from a statistical value of the one or more frequencies of the predetermined number from the first set of combinations of the audio data set 404, the data parser 302 determines that the first portion having the first amplitude and the first frequency is the audio data 304 that is generated based on sounds from the source 1 that is similar in type to one or more of the sources (n−m) through (n−1) of the predetermined number. To illustrate, the data parser 302 assigns to the source 1 an identification that is the same as one of the identifications 412 assigned to the one of the sources (n−m) through (n−1) from the predetermined number of the sources (n−m) through (n−1).

Further, in the example, the data parser 302 compares the second amplitude of the second portion of the audio data 224 with the one or more amplitudes of the predetermined number and compares the second frequency with the one or more frequencies of the predetermined number. The one or more amplitudes are from a second set of combinations, including the second combination, of the audio data set 408 (FIG. 4) and the one or more frequencies are from the second set of combinations of the audio data set 408. In response to determining that the second amplitude is within the preset amplitude range from a statistical value of the one or more amplitudes of the predetermined number from the second set of combinations of the audio data set 408 and the second frequency is within the preset frequency range from a statistical value of the one or more frequencies of the predetermined number from the second set of combinations of the audio data set 408, the data parser 302 determines that the second portion having the second amplitude and the second frequency is the audio data 306 that is generated based on sounds from the source 2 that is similar in type to one or more of the sources n through (n+p) of the predetermined number. To illustrate, the data parser 302 assigns to the source 2 an identification that is the same as one of the identifications 414 assigned to the one of the sources n through (n+p) from the predetermined number of the sources n through (n+p).

The data parser 302 provides the audio data 304 with the identification of the source 1 to the classifier 502 in addition to an indication that the audio data 304 is generated based on sounds from the source 1 that is similar in type to one or more of the sources (n−m) through (n−1) of the predetermined number. For example, the data parser 302 provides the audio data 304 to the classifier 502 within a predetermined time interval from, such as simultaneously with, sending the identification of the source 1 to the classifier 502 and the indication that the audio data 304 generated based on sounds from the source 1 is similar to one or more of the sources (n−m) through (n−1) of the predetermined number. In response to receiving the audio data 304 with the identification of the source 1 and the indication that the audio data 304 generated based on sounds from the source 1 is similar to one or more of the sources (n−m) through (n−1) of the predetermined number, the classifier 502 classifies the audio data 304 as being beneficial to the user 1. For example, the classifier 502 is trained to identify that the one or more of the sources (n−m) through (n−1) of the predetermined number has the indications 406 of beneficiality. Upon being trained to identify that the one or more of the sources (n−m) through (n−1) of the predetermined number has the indications 406 of beneficiality and upon receiving the indication, from the data parser 302, that the sounds are output from the source 1 that is similar to the one or more of the sources (n−m) through (n−1) of the predetermined number, the classifier 502 determines that the audio data 304 generated based the sound 220 from the source 1 has the same type of beneficiality, such as is beneficial, to a user as that of the indications 406 of the predetermined number.

Similarly, the data parser 302 provides the audio data 306 with the identification of the source 2 to the classifier 502 in addition to an indication that the audio data 306 is generated based on sounds from the source 2 that is similar in type to one or more of the sources n through (n+p) of the predetermined number. For example, the data parser 302 provides the audio data 306 to the classifier 502 within the predetermined time interval from, such as simultaneously with, sending the identification of the source 2 to the classifier 502 and the indication that the audio data 306 generated based on sounds from the source 2 is similar to one or more of the sources n through (n+p) of the predetermined number. In response to receiving the audio data 306 with the identification of the source 2 and the indication that the audio data 306 generated based on sounds from the source 2 is similar to one or more of the sources n through (n+p) of the predetermined number, the classifier 502 classifies the audio data 306 as not being beneficial to the user 1. For example, the classifier 502 is trained to identify that the one or more of the sources n through (n+p) of the predetermined number has the indications 410 of lack of beneficiality. Upon being trained to identify that the one or more of the sources n through (n+p) of the predetermined number has the indications 410 of lack of beneficiality and upon receiving the indication, from the data parser 302, that the sounds are output from the source 2 that is similar to the one or more of the sources n through (n+p) of the predetermined number, the classifier 502 determines that the audio data 306 generated based the sound 222 from the source 2 has the same type of beneficiality, such as lack of beneficiality, to a user as that of the indications 410 of the predetermined number.

FIG. 6 illustrates components of an example device 600, such as a client device or a server system, described herein, that can be used to perform aspects of the various embodiments of the present disclosure. This block diagram illustrates the device 600 that can incorporate or can be a personal computer, a smart phone, a video game console, a personal digital assistant, a server or other digital device, suitable for practicing an embodiment of the disclosure. The device 600 includes a CPU 602 for running software applications and optionally an operating system. The CPU 602 includes one or more homogeneous or heterogeneous processing cores. For example, the CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. The device 600 can be a localized to a player, such as a user, described herein, playing a game segment (e.g., game console), or remote from the player (e.g., back-end server processor), or one of many servers using virtualization in a game cloud system for remote streaming of gameplay to clients.

A memory 604 stores applications and data for use by the CPU 602. A storage 606 provides non-volatile storage and other computer readable media for applications and data and may include fixed disk drives, removable disk drives, flash memory devices, compact disc-read only memory (CD-ROM), digital versatile disc-ROM (DVD-ROM), Blu-ray, high definition-digital versatile disc (HD-DVD), or other optical storage devices, as well as signal transmission and storage media. User input devices 608 communicate user inputs from one or more users to the device 600. Examples of the user input devices 608 include keyboards, mouse, joysticks, touch pads, touch screens, still or video recorders/cameras, tracking devices for recognizing gestures, and/or microphones. A network interface 614, such as a NIC, allows the device 600 to communicate with other computer systems via an electronic communications network, and may include wired or wireless communication over local area networks and wide area networks, such as the internet. An audio processor 612 is adapted to generate analog or digital audio output from instructions and/or data provided by the CPU 602, the memory 604, and/or data storage 606. The components of device 600, including the CPU 602, the memory 604, the data storage 606, the user input devices 608, the network interface 614, and an audio processor 612 are connected via a data bus 622.

A graphics subsystem 620 is further connected with the data bus 622 and the components of the device 600. The graphics subsystem 620 includes a graphics processing unit (GPU) 616 and a graphics memory 618. The graphics memory 618 includes a display memory (e.g., a frame buffer) used for storing pixel data for each pixel of an output image. The graphics memory 618 can be integrated in the same device as the GPU 616, connected as a separate device with the GPU 616, and/or implemented within the memory 604. Pixel data can be provided to the graphics memory 618 directly from the CPU 602. Alternatively, the CPU 602 provides the GPU 616 with data and/or instructions defining the desired output images, from which the GPU 616 generates the pixel data of one or more output images. The data and/or instructions defining the desired output images can be stored in the memory 604 and/or the graphics memory 618. In an embodiment, the GPU 616 includes three-dimensional (3D) rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from the graphics memory 618 to be displayed on the display device 610. The display device 610 can be any device capable of displaying visual information in response to a signal from the device 600, including a cathode ray tube (CRT) display, a liquid crystal display (LCD), a plasma display, and an organic light emitting diode (OLED) display. The device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (Saas). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a GPU since it will be doing a large number of relatively simple mathematical operations (e.g., matrix transformations). Other game engine segments that require fewer but more complex operations may be provisioned with a processing entity associated with one or more higher power CPUs.

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and an input/output (I/O) interface. The client device can be a personal computer (PC), a mobile phone, a netbook, a personal digital assistant (PDA), etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device system, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In an embodiment, although the embodiments described herein apply to one or more games, the embodiments apply equally as well to multimedia contexts of one or more interactive spaces, such as a metaverse.

In one embodiment, the various technical examples can be implemented using a virtual environment via the HMD. The HMD can also be referred to as a virtual reality (VR) headset. As used herein, the term “virtual reality” (VR) generally refers to user interaction with a virtual space/environment that involves viewing the virtual space through the HMD (or a VR headset) in a manner that is responsive in real-time to the movements of the HMD (as controlled by the user) to provide the sensation to the user of being in the virtual space or the metaverse. For example, the user may see a three-dimensional (3D) view of the virtual space when facing in a given direction, and when the user turns to a side and thereby turns the HMD likewise, the view to that side in the virtual space is rendered on the HMD. The HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on the HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, compact disc-read only memories (CD-ROMs), CD-recordables (CD-Rs), CD-rewritables (CD-RWs), magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

It should be noted that in various embodiments, one or more features of some embodiments described herein are combined with one or more features of one or more of remaining embodiments described herein.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for reproducing external sounds for output during game play, comprising:
receiving audio data captured from a sound output by a real-world object during a play of a game by a user;
determining that the sound is beneficial to the user;
modifying the audio data to output modified audio data in response to said determining that the sound is beneficial to the user; and
providing the modified audio data to facilitate outputting the modified audio data via a speaker of a client device to emphasize the sound beneficial to the user.

2. The method of claim 1, wherein said determining that the sound is beneficial to the user is performed by an artificial intelligence model.

3. The method of claim 2, further comprising:
identifying, by the artificial intelligence model, a source of the sound;
classifying, by the artificial intelligence model, the audio data to determine that the audio data is beneficial to the user.

4. The method of claim 3, further comprising:
comparing a value of a parameter of the audio data with a plurality of values of the parameter of audio information from a predetermined number of sources;
determining that the value of the parameter is within a preset range from the plurality of values of the parameter of audio information to identify the source of the sound.

5. The method of claim 4, wherein the parameter is frequency or amplitude.

6. The method of claim 3, wherein said classifying includes:
identifying a classification of the predetermined number of sources;
assigning the classification to the audio data to classify the audio data.

7. The method of claim 1, wherein the speaker is of a headphone that is worn by the user, wherein the speaker is not of a display device on which the game is displayed.

8. A server system reproducing external sounds for output during game play, comprising:
a processor configured to:
receive audio data captured from a sound output by a real-world object during a play of a game by a user;
determine that the sound is beneficial to the user;
modify the audio data to output modified audio data in response to the determination that the sound is beneficial to the user; and
provide the modified audio data to facilitate outputting the modified audio data via a speaker of a client device to emphasize the sound beneficial to the user; and
a memory device coupled to the processor.

9. The server system of claim 8, wherein the processor is configured to execute an artificial intelligence model to determine that the sound is beneficial to the user.

10. The server system of claim 18, wherein the processor is configured to:
identify, using the artificial intelligence model, a source of the sound;
classify, using the artificial intelligence model, the audio data to determine that the audio data is beneficial to the user.

11. The server system of claim 10, wherein the processor is configured to:
compare a value of a parameter of the audio data with a plurality of values of the parameter of audio information from a predetermined number of sources;
determine that the value of the parameter is within a preset range from the plurality of values of the parameter of audio information to identify the source of the sound.

12. The server system of claim 11, wherein the parameter is frequency or amplitude.

13. The server system of claim 10, wherein to classify the audio data, the processor is configured to:
identify a classification of the predetermined number of sources;
assign the classification to the audio data to classify the audio data.

14. The server system of claim 8, wherein the speaker is of a headphone that is worn by the user, wherein the speaker is not of a display device on which the game is displayed.

15. A non-transitory computer readable medium containing program instructions for reproducing external sounds for output during game play, wherein execution of the program instructions by one or more processors of a computer system causes the one or more processors to carry out operations of:
receiving audio data captured from a sound output by a real-world object during a play of a game by a user;
determining that the sound is beneficial to the user;
modifying the audio data to output modified audio data in response to said determining that the sound is beneficial to the user; and
providing the modified audio data to facilitate outputting the modified audio data via a speaker of a client device to emphasize the sound beneficial to the user.

16. The non-transitory computer readable medium of claim 15, wherein the operation of determining that the sound is beneficial to the user is performed by an artificial intelligence model.

17. The non-transitory computer readable medium of claim 16, wherein the operations comprise:
identifying, by the artificial intelligence model, a source of the sound;
classifying, by the artificial intelligence model, the audio data to determine that the audio data is beneficial to the user.

18. The non-transitory computer readable medium of claim 17, wherein the operations comprise:
comparing a value of a parameter of the audio data with a plurality of values of the parameter of audio information from a predetermined number of sources;
determining that the value of the parameter is within a preset range from the plurality of values of the parameter of audio information to identify the source of the sound.

19. The non-transitory computer readable medium of claim 18, wherein the parameter is frequency or amplitude.

20. The non-transitory computer readable medium of claim 17, wherein the operation of classifying includes:
identifying a classification of the predetermined number of sources;
assigning the classification to the audio data to classify the audio data.
